(19) United States
(12) Patent Application Publication
(10) Pub. No.: US 2020/0125394 A1
(43) Pub. Date: Apr. 23, 2020

(54) DATA ANALYTICS PLATFORM

(71) Applicant: The Boston Consulting Group, Inc., Boston, MA (US)

(72) Inventors: Andrea Gallego, Boston, MA (US); Allen Chen, Seattle, WA (US); Max Rady, Paris (FR)

(21) Appl. No.: 16/163,375

(22) Filed: Oct. 17, 2018

(51) Int. Cl. G06F 9/48; G06N 3/08; G06N 3/10; G06N 3/04

(52) U.S. Cl. CPC G06F 9/48; G06N 3/04; G06N 3/105; G06N 3/08

(57) ABSTRACT

The production and deployment of models for relating input variables to output variables can be improved through the use of containers. Conventional methods for creating and deploying models suffer from problems such as having to transmit large amounts of data, having to re-train models each time they are executed, behavioral inconsistencies between model instances, and compatibility issues between a model and a host computing environment. The use of containers for generating and deploying models can help mitigate these issues. Systems and methods are provided for generating lightweight and standalone container images that can be executed reliably within a variety of computing environments. A model is paired with a contextual application for using the model in a particular context. Models can be re-used in different contexts when paired with different contextual applications.

### BACKGROUND

As the implementation of machine learning and data science techniques are becoming increasingly ubiquitous, there is a corresponding increase in the amount of data that has to be transmitted and processed. The use of containers (e.g., Docker containers) has been realized as beneficial for distributing trained models; however, the use of containers generally results in one of two unsatisfactory outcomes. In the first case, the container supports an application for contextual awareness, but a trained model is stored outside of the container image creating an external dependency. This is not advantageous as the container supporting the application cannot be run in a portable and standalone manner. Additionally, since there is an external dependency, the behavior of the application cannot be guaranteed because changes to the application logic and its execution environment may be introduced when introducing a runtime step for pulling a model from an external source. In the second case, models must be re-trained each time a container image is executed. This is slow and also requires that the training data be built into the container image, which for large datasets can be impractical.

### BRIEF DESCRIPTION OF THE DRAWINGS

Various embodiments in accordance with the present disclosure will be described with reference to the drawings, in which:

FIG. 1 depicts a neural network model that can be used to generate a relevant set of output values (e.g., predictive outcomes) based on a set of input values.

FIG. 2 illustrates how containers are implemented on computing hardware.

FIGS. 3a-b depict a two-stage process of generating a hydrated container image.

FIG. 3c depicts the execution of the hydrated container image generated in FIGS. 3a-b.

FIG. 4 depicts an example two-stage process for generating a container image with a trained model.

FIG. 5 depicts a process for adaptively using a trained model in different contexts.

FIG. 6 depicts a system for generating and providing trained models for use one or more contexts.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

With advancements in computing technology the use of machine learning for predictive modeling is quickly becoming ubiquitous. Predictive models are now used for many applications including financial modeling to self-driving cars. One difficulty with the use of predictive models in real-world applications is that trained models are generally designed for a specific use context and cannot be easily adapted for other use cases. Predictive models by themselves are not contextually aware of why they are needed, where they are needed, and the broader ecosystem of inputs and outputs that may be in communication with the model. Trained models are generally tied to applications that can only be executed within a particular environment. Using conventional methods, it can be difficult and costly to configure a model so that the model can be used in the context of a new computing environment (e.g., a different host operating system) or so that it can be used for a different application (e.g., so that the model can be used as a batch predictor rather than a Representation State Transfer (REST) application programming interface (API)). Often, using a model in a different context may require complete re-training of the model using the raw data. In some cases, a special application or script may be needed so that a model can be used in a new context.

In this disclosure methods and systems are presented for developing trained models and using them in various contexts. As will be discussed in greater detail herein, the disclosed methods reduce computational inefficiencies by enabling models to be re-used in a variety of contexts eliminating the need to re-train a model for each use case. Applications for providing contextual awareness are paired with a model and stored in a container image. These lightweight container images can then be deployed for use in edge computing applications. Since container images run reliably regardless of a computing environment's host operating system, it is not necessary to create a distinct version of an application for each computing system that the model might be deployed on.

Models:

A model is a function that maps, using a set of parameters or values, one or more input variables to one or more output variables. The set of parameters used by a model are herein referred to as the model values. In some cases, models may include one or more machine learning algorithms such as linear regression models, logistic regression models, linear discriminate analysis algorithms, classification and regression trees, Naive Bayes algorithms, K-nearest neighbors algorithms, learning vector quantization algorithms, support vector machines, Bagging and Random Forests algorithms, neural networks and the like. While some examples herein are given in the context of a deep learning model or a neural network model, it should be understood that other models or combinations of models familiar to those of skill in the art can also be used. A model is useful when the model values are set to reliably predict an output for a given input. Determining trained model values is done by applying one or more machine learning techniques to a set of training data. Training can occur when a model is first created, and in some cases, a model can continue to be trained over time as more training data is made available.

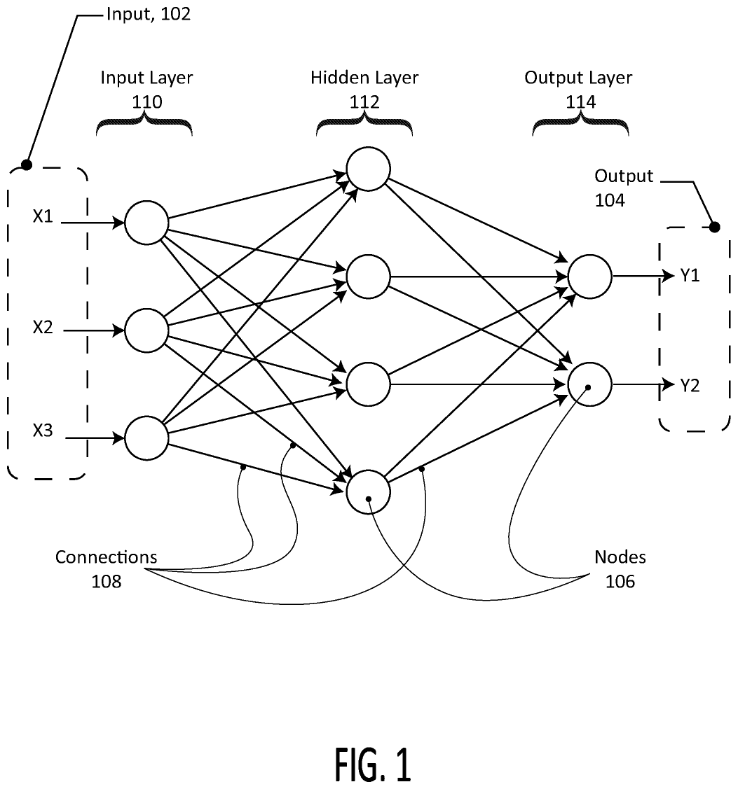

FIG. 1 depicts an example of neural network model 100 which takes a set of inputs 102 (e.g., depicted input vector [X1, X2, X3]) to produce a set of outputs 104 (e.g., depicted output vector [Y1, Y2]). A neural network model is defined by a set of activation functions and model parameters (weights and biases) which are used to produce a set of outputs for a given set of inputs. The neural network model consists of a series of nodes 106 having a series of connections 108 that pass values between nodes in the direction of the arrows. The nodes are organized into layers including an input layer 110, an output layer 114, and one or more hidden layers 112. Each connection has an associated weight coefficient that is multiplied with a value passed through the connection and is delivered to the corresponding node as a weighted value. Nodes receive one or more weighted values and apply the sum of incoming weighted values to an activation function. The output of the activation function is then transmitted out of one or more connections leaving the respective node.

In some cases, a node can have a bias value that is added to the weighted sum before the sum is applied to the activation function. In some cases, activation functions may not transform the weighted sum, and in some cases, weights may be given a value of 1. For instance, nodes in the input layer 110 and the associated connections that provide in values to the input layer generally do not modify any values from a set of inputs 102.

One of skill in the art will understand that a neural network model can take the form of any number of neural networks including Perceptron (P) networks, Feed Forward (FF) networks, Radial Basis Networks (RBF), Deep Feed Forward (DFF) networks, Recurrent Neural Networks (RNN), Long/Short Term Memory (LSTM) Networks, Gated Recurrent Unit (GRU) networks, Auto Encoder (AE) Networks, Variational AE Networks (VAE), Denoising AE Networks (DAE), Sparse AE Networks (SAE), Markov Chain (MC) Networks, Hopfield Networks (HN), Boltzmann Machine (BM) Networks, Restricted BM Networks (BRM), Deep Belief Networks (DBN), Deep Convolutional Networks (DCN), Deconvolutional Networks (DN), Deep Convolutional Inverse Graphics Networks (DCIGN), Generative Adversarial Networks (GAN), Liquid State Machine (LSM) Networks, Extreme Learning Machine (ELM) Networks, Echo State Networks (ESN), Deep Residual Networks (DRN), Kohonen Networks (KN), Support Vector Machine (SVM) Networks, Neural Turing Machine (NTM) Networks, and the like. In some cases, a model is based on more than one machine learning model or algorithm.

Models are only useful when configured with an appropriate set model values, which in the case of neural network models include weight values and bias values. Training is the process of determining and/or optimizing model values using any number of machine learning techniques known to those of skill in the art. As discussed, elsewhere herein, a training application can be used to generate trained model values. In some cases, training may involve establishing a model type or structure, and in some cases, training may simply refer to the refinement of model values—e.g., when model values are refined using additional training data.

Models are generated with a shared set of characteristics so that models can be used interchangeably between applications, as will be discussed in greater detail herein. For example, models may be packaged in the same file format, written in the same programming language, made using the same toolkit, and/or made with a set of common input and output functions. A software program can then be written to interact with any model having the shared set of characteristics. For example, a software application may be written to generate a REST API from any model written in Python using the scikit-learn machine learning toolkit. In some cases, models can be generated using other libraries such as TensorFlow, Keras, MLib and the like. In some cases, a contextual application that interfaces between a model and a host computing environment is adaptive and can be configured to work with a variety of model types having a shared set of characteristics. For example, at runtime, a contextual application may be configured to detect the type of model (including the inputs and outputs of a model) so that the model can be applied in an appropriate manner within a host computing environment.

Once models are trained they can be stored in a model library. A model library may be, e.g., stored on a local server or in cloud storage. In some cases, models stored in the model library can include information indicating a model version, as well as the data and/or training code used to produce the model. In some cases, models can include information describing relationships to other models in the model library, e.g., whether another model in the library was generated using a common set of training data. In some cases, information about models in the model library can be stored in a separate library file. As discussed herein, models from the model library can be retrieved and packaged with software to provide context to the model. The result is a contextually-aware model that is a portable container image that can be run on edge computing systems.

Containers:

Containers provide a method of operating system virtualization that allows an application and its dependencies to run in resource-isolated processes. A container image is a lightweight, standalone, executable package of software that includes everything needed to run an application: code, runtime, system tools, system libraries, and settings. Container images become containers at runtime. The use of containers allows an application's code, configurations, and dependencies to be packaged into easy to use building blocks that deliver environmental consistency, operational efficiency, developer productivity, and version control. Containers can help ensure that applications deploy quickly, reliably, and consistently regardless of the deployment environment. Containers also provide granular control over resources which can improve the efficiency of computational resources.

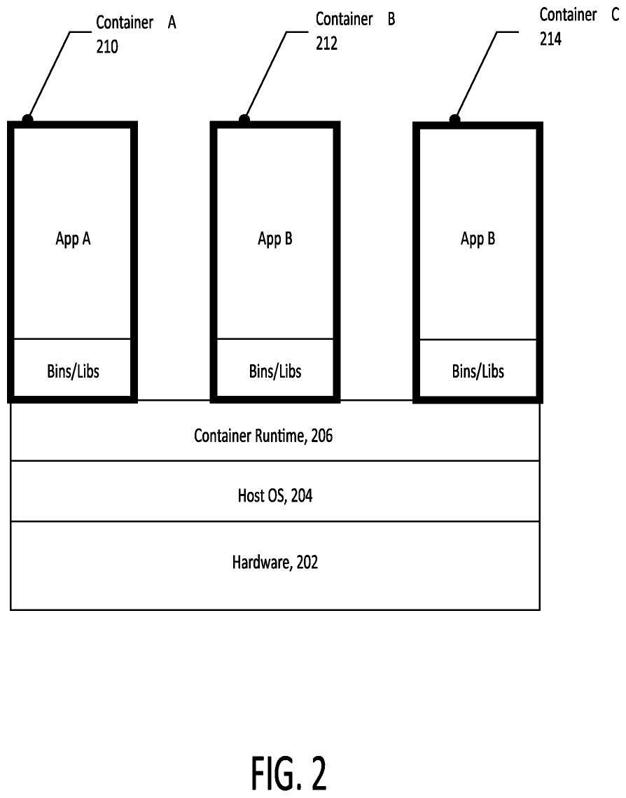

FIG. 2 depicts a diagram of container implementation. Hardware 202 can be, e.g., the computing hardware of a smartphone, personal computer, a server, one or more cloud computing resources, and the like. The hardware can support a host operating system 204 which can be, e.g., Mac OS, Windows, Linux, and the like. Running within the host operating system is a container runtime environment 206—a program that can create and execute container images to run various container instances such as 210, 212, and 214. As described, each container includes the needed resources (i.e., the code, runtime, system tools, system libraries, and settings) for running a respective application. Each instance of a container (e.g., 210, 212, and 214) can share the kernel of the host operating system 204.

Containers encapsulate all the necessary application files and software dependencies and serve as a building block that can be deployed on any compute resource regardless of software, operating system, or hardware configurations (e.g., the same container can run on an Ubuntu laptop or a Red Hat Enterprise Linux production server). Whatever is packaged in a container locally will deploy and run the same way whether in testing or production. This allows for contextually-aware models to be deployed reliably and consistently regardless of environment.

An allocated amount of memory, disk space, and CPU can be designated for use by each container instance. Containers have fast boot times because each container is only a process on the operating system running an application and its dependencies. This reduced footprint enables containers and the applications they contain to be quickly created and terminated. Containers also provide process isolation, which allows each application and its dependencies to be put into a separate container. There are no shared dependencies or incompatibilities because each container is isolated from the other.

Containers allow versions of an application code and their dependencies to be tracked. For example, container images have a manifest file (e.g., a Dockerfile) for tracking image versions and inspecting differences between versions. Distribution of container images can be provided by a container registry system. Container registry systems are used for storing and distributing container image. Examples of registry systems that may be used include, e.g., Docker Hub from Docker, Quay from CoreOS, Google's Container Registry (GCR), and Amazon Elastic Container Registry.

Container Hydration:

Container hydration refers to the process of pairing a contextual application with a trained model in an executable container image. While conventional methods of applying trained models for real-world applications often requires a close coupling to a system's core computing environment, hydrated containers are lightweight and can easily be deployed at various edge computing environments.

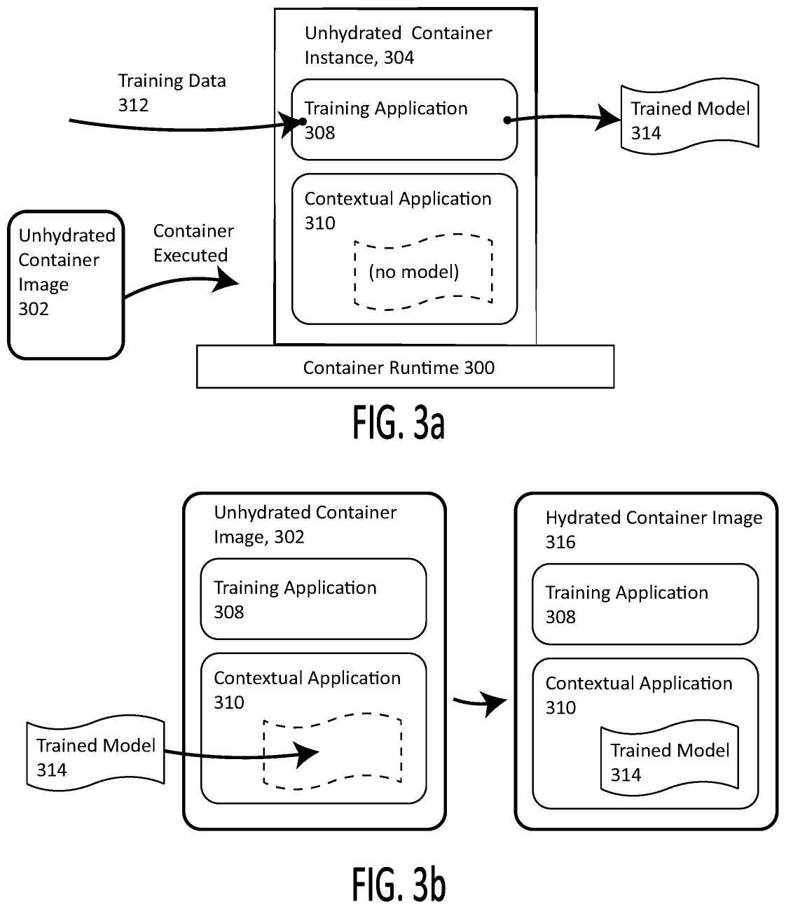

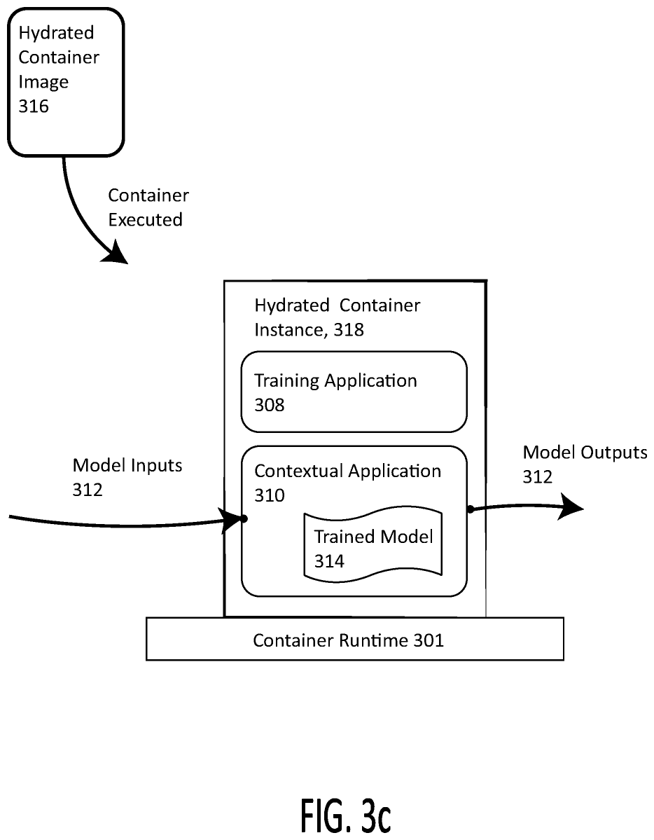

In some cases, container hydration can be performed using a two-stage process reflected in FIGS. 3a and 3b. In the first stage of container hydration, reflected in FIG. 3a, an unhydrated container image 302 is executed as a container instance 304 using container runtime 300. As discussed in FIG. 2, the container runtime operates within a host operating system and is associated with corresponding hardware. The unhydrated container instance 304 runs training application 308 and also has a contextual application 310. Training application 308 receives input training data 312 and generates a trained model 314 using the training data. Training application 306 may utilize any number of machine learning techniques to produce trained model 314. In some cases, a general model structure or type is provided along with the training data to the training model application, and the training application determines trained model parameters. In some cases, training application 308 may be used to determine the model type, structure, and values based on a set of input training data 3012. In this first stage, contextual application 310 in instance 304 does not have a model to reference.

In the second stage, reflected in FIG. 3b, a hydrated container image 316 is created. To create the hydrated container image 316, the trained model 314 is built into a copy of unhydrated container image 302. A hydrated container image 316 is thus created which includes the training application 308 and contextual application 310 that references trained model 314. The hydrated container can be stored at a container registry where it can be easily delivered as a self-contained package to various intended use locations.

FIG. 3c depicts an example computing environment in which a hydrated container is executed. After the hydrated container 316 has been pulled from a container registry or other storage location, the container is executed to create hydrated container instance 318 using container runtime 301. Contextual application 310 receives input data from the corresponding compute environment and provides appropriate model inputs to the trained model 314. Model outputs of the trained model are received by the contextual application which may be configured to apply the model outputs within the compute environment (e.g. by generating a rest API) or transmit the model outputs to an appropriate destination. In some cases, contextual application 310 may receive a large dataset or a data stream, and the application is configured to determine a subset of input data to provide to the trained model. Similarly, in some cases, contextual application 310 can be configured to determine a subset of model output data 314 for use within the host computing environment.

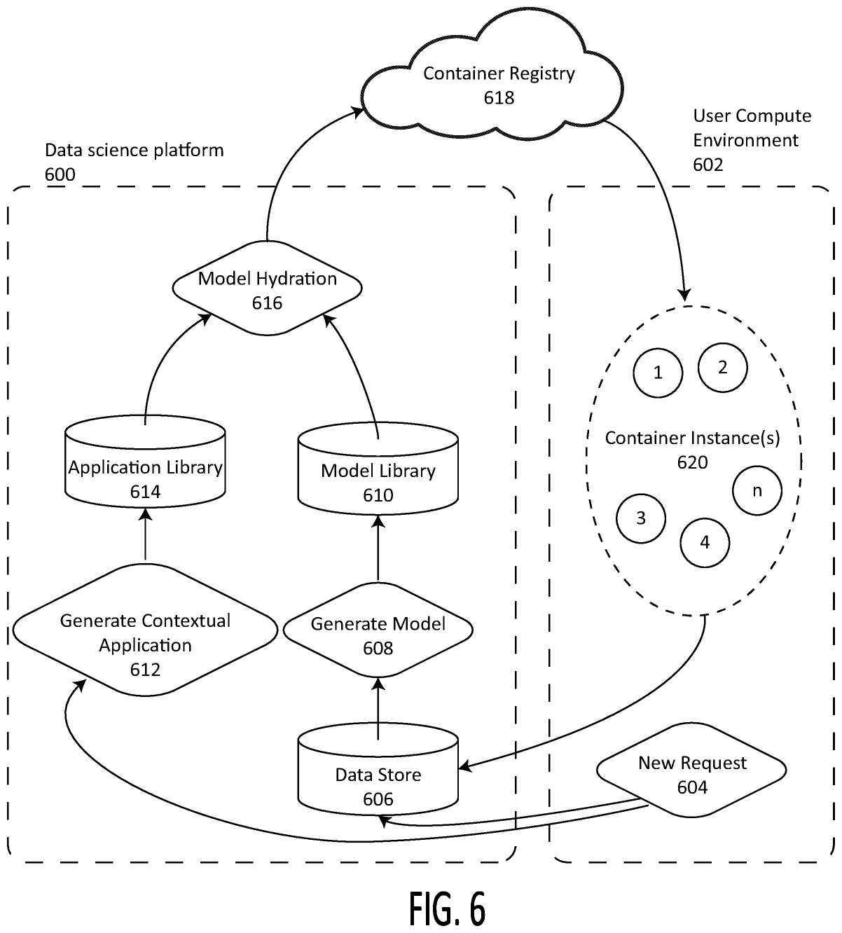

In some cases, hydrated container instance 318 can be configured to update trained model 314 based on additional training data that is acquired after the model has been trained. For instance, model inputs, outputs, and/or other information that can be collected and used as training data which may be provided to training application 308. In some cases, a new model can be generated (or model values can be updated) using training application 308 at the same time that contextual application 314 is used to provide predictive results using a different model. In some cases, training application 308 and/or contextual application 314 can be configured to communicate with corresponding applications of other instances of the same hydrated container. In some cases, training application 308 and/or contextual application 314 is configured to communicate and send data back to a data science platform (e.g., see FIG. 6), so that the data can be leveraged for training new models or generating revised model parameters.

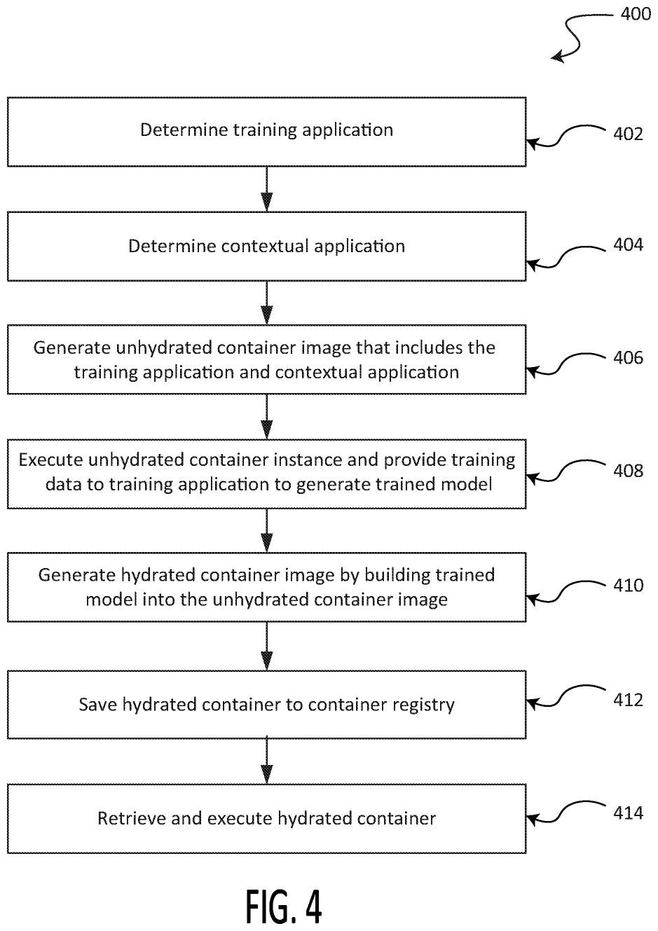

FIG. 4 illustrates an example two-stage method 400 for generating a contextually-aware container image with a trained model. It should be understood that, for this and other processes discussed herein, there can be additional, fewer, or alternative steps, performed within the scope of the various embodiments unless otherwise stated. In operation 402 a training application is determined, selected, or in some cases, generated. A training application may be determined, for instance, based on a particular type of model that is desired. In some cases, determining the training application may include determining the structure of the model. For instance, the number of nodes, number of hidden layers, the types of activations functions, and the connections between nodes of a neural network can be determined. Using a set of training data, the training application is configured to generate a trained model which can be used by a corresponding contextual application. The shared model characteristics of generated models may be the file format used to store the model, a toolbox used to generate the model, a function used of the model, and the like.

In operation 404, a contextual application is determined. The contextual application is configured to interface between the model and compute environments in which a model will be used. If the training application is configured to generate models using the scikit-learn toolbox for Python, the contextual application may simply be configured to communicate with the model using the various scikit-learn functions. Likewise, the contextual application may be configured to work with all models having another set of shared characteristics. In this manner, the contextual application can pass input data to and receive corresponding output data from a trained model. The contextual application can also interface with a host computing environment and can be configured to identify model input data to provide to a trained model and identify appropriate output data to transmit back to a host computing environment. In some cases, the contextual application may be developed specifically for use with a particular model or for transmitting model inputs and outputs in a particular context. In some cases, the contextual application may be selected from a corresponding library of applications that are compatible with models having the shared set of characteristics. For instance, a contextual application may be selected from a library that is configured to generate a REST API from any model created using the scikit-learn toolbox for Python. Alternatively, a contextual application could be selected to be used as a batch predictor.

In operation 406, an unhydrated container image is created that includes both the training application and the contextual application. In operation 408, the hydrated container image is executed as a container instance. Training data is provided to the training application of in the container instance which generates a trained model. In operation 410, a hydrated container image is created which includes the training application, the contextual application, and the trained model. In some cases, other than having the trained model, the hydrated container image may be the same the corresponding unhydrated container image generated in operation 406. In operation 412, the hydrated container image is stored in a container registry system 412. Lastly, in operation 414, host computing environments that wish to use the model can retrieve and execute the hydrated container image. In some cases, after generating a trained model (or at least generating trained model values) in operation 410, the trained model is saved to a model library. Once stored in the model library the trained model may be retrieved and paired with an appropriate contextual application for an intended use case.

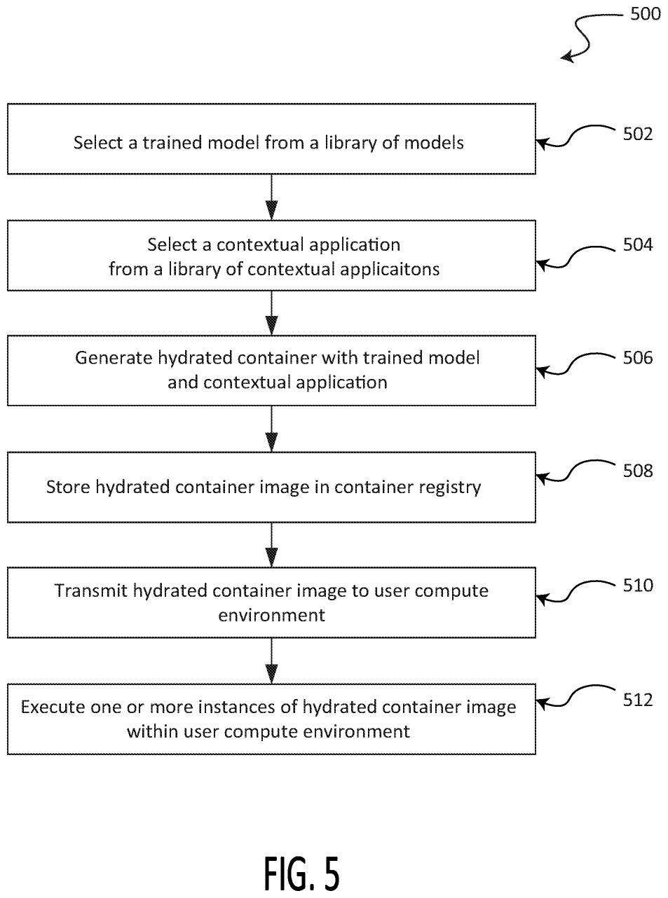

FIG. 5 depicts a process 500 for adaptively using a trained model in different contexts. In operation 502 a model is selected from a library of saved models. The library of trained models may include trained models corresponding to, e.g., different training data sets, different input parameters, different output parameters, and the like. In operation 504 a container with a corresponding contextual application is selected based on the intended use of the model. In some cases, a contextual application is selected from a library of applications which stores contextual applications that can interface with models having a shared set of characteristics. In some cases, a contextual application may be paired with a training application. After a model and an application have been selected, a hydrated container is generated in operation 506. The hydrated container includes the selected contextual application and the trained model. In some cases, such as when the two-stage container hydration process is used (depicted in FIGS. 3a-3b), there may also be other applications in the container such as a training application. The hydrated container image can be stored in a container registry such as Docker Hub or another cloud-based registry service in operation 508. In operation 510, a computing environment where the model will be used can then retrieve the hydrated container image and execute the container as one or more instances to provide predictions, make determinations, and the like.

Using the method in FIG. 5, a trained model can be easily re-used in a variety of contexts without needing to re-train a model for each use case. Similarly, once a contextual application has been created, it can be used with a plurality of models having characteristics that the model is configured to interface with. This interchangeability simplifies the process needed to use a model in new contexts. As an illustrative example, consider the case when a forecasting model is generated. In a first use case, the forecasting model may be leveraged for online prediction (e.g., a REST API) by hydrating the model with a first contextual application. In a second use case, the model may be levered for offline prediction (e.g., for batch jobs) when the model is hydrated with a second contextual application. In a third use case, it may be determined that the model should be embedded into a high-level application—for example, a dashboard web application may require the forecasting model to function properly. If this is the case, the model can be hydrated into a container along with the high-level application.

FIG. 6 illustrates how a data science platform 600 can be used for generating and providing trained models that can be used in various contexts. The data science platform contains one or more processors and is configured with memory for storing application library 614, a model library 610, and a data store 606. Data store 606 may be used to store raw, filtered, or processed data for use in training models or re-training models. In some cases, the data store may retain training data after it has been used, and in some cases, some or all of the data may be removed after it has been used to train a corresponding model. Model library 610 can be used to store various trained models. In some cases, model library 610 can also store model templates. In some configurations, the model library may contain information indicating how models have been trained and what data was used during the training process. For instance, if a model is behaving differently than expected, it may be that a bad set of data was used to train the model. In such cases, a different model could be selected as a replacement, or a new model could be trained without using the identified bad set of data. Application library 614 stores contextual applications that are configured to provide contextual awareness and interface with a model having a shared set of characteristics. Applications that are retrieved from library 614 can be paired with containers when a hydrated container image is generated 616.

A user compute environment 602 can issue a request 604 to data science platform 600 for a hydrated container image. The request may include a use-case selection indicating a context or application for which the hydrated container is to be used. For instance, the selection may correspond to a stored contextual application in application library 614 that allows the model to be used as a batch predictor. If an appropriate contextual application does not yet exist, an application may need to first be created 612. Contextual applications can then be stored in application library 614 for future requests. A request may also include the transmission of data to data store 606 to be used for generating a corresponding model. In some cases, an appropriate container (e.g., a container with a training application) may be selected from library 614 and used to generate a trained model 608 using a two-stage method as previously described (see, e.g., FIGS. 3a-3b and FIG. 4). After a model is generated, it can be stored in model library 610. In some cases, a request 604 may be for a model that is already stored in model library 610. After the appropriate containers and models are either generated (612 and 608) or located in their respective libraries (614 and 610), a hydrated container image is created 616. Thy hydrated container image is stored in container registry 618, which may be located in the cloud. The container images can then be downloaded to user compute environment 602 and instances 620 of the retrieved container can be run within various compute environments to provide predictive results, determinations, instructions, and the like by processing data with the requested trained model.

In some cases, if an appropriate hydrated container image already exists in container registry 618, it can be retrieved directly. In some cases, container instances 620 may be configured to capture data correlated with the use of the model, and the data can be transmitted back to data store 606 where it can be made available to data science platform 600 for further refining model values. Refined model values can be reflected in updated models stored in model library 610 and container images stored in registry 618. In some cases, refined model values can be transmitted back to one or more container instances where they can replace existing model values. In some cases, container instances themselves may continue to train and revise a model locally. In cases where model parameters are revised by a container instance, e.g., using a training application, revised model values can be transmitted back to the data science platform. In some cases, continued training can occur periodically or after a threshold quantity of available training data is made available. In other cases, training can occur continuously as training data becomes available.

The various embodiments can be further implemented in a wide variety of operating environments, which may include one or more user computers or computing devices which can be used to operate any of a number of applications. Compute environments used by the data science platform or by a user can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM° as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
determining a training application, the training application configured to generate models relating one or more input variables to one or more output variables based on received training data, wherein models are generated with a first set of characteristics and a first set of model values;
determining a contextual application from a plurality of contextual applications, the contextual application configured to interface with a model having the first set of characteristics and communicate with a computing environment;
generating a first container image comprising the training application and the contextual application;
generating a trained model, by executing the first container image as a first container instance and providing training data to the respective training application of the container instance; and
generating a second container image comprising the contextual application, and the trained model.

2. The computer-implemented method of claim 1, further comprising:
executing the second container image on the computing environment as a second container instance;
providing input variable data to the model of the second container instance via the respective contextual application; and
providing output variable data generated by the model of the second container instance to the computing environment.

3. The computer-implemented method of claim 2, wherein the input variable data comprises a data stream.

4. The computer-implemented method of claim 2, wherein the input variable data comprises a data set.

5. The computer-implemented method of claim 2, further comprising:
executing the second container image on a different computing environment as a third container instance;
providing input variable data to the model of the third container instance via the respective contextual application; and
providing output variable data generated by the model of the third container instance to the different computing environment.

6. The computer-implemented method of claim 1, wherein the contextual application is configured to generate a Representation State Transfer (REST) Application Programming Interface (API) relating the one or more input variables to one or more output variables.

7. The computer-implemented method of claim 1, wherein the contextual application is configured to generate a batch predictor relating the one or more input variables to one or more output variables.

8. The computer-implemented method of claim 1, wherein the second container further comprises the training application.

9. The computer-implemented method of claim 1, wherein the first set of characteristics comprises a set of functions associated with a toolbox for generating models.

10. The computer-implemented method of claim 1, wherein the model is a neural network model.

11. The computer-implemented method of claim 1, wherein the trained model has a structure that is determined automatically by the training application of the first container instance.

12. A computer-implemented method, comprising:
receiving a first request for using a model in a first context;
determining a first contextual application from a plurality of contextual applications based on the first context;
retrieving the model from a first library and the first contextual application from a second library;
packaging the first contextual application and the model in a first container image;
receiving a second request for using the model in a second context, the second context being different from the first context;
determining a second contextual application from the plurality of applications based on the second context;
retrieving the second contextual application from a second library; and
packaging the second contextual application and the model in a second container image.

13. The computer-implemented method of claim 12, wherein the first context is a Representation State Transfer (REST) Application Programming Interface (API).

14. The computer-implemented method of claim 12, wherein the first context corresponds to a batch predictor.

15. The computer-implemented method of claim 12, further comprising storing the first container image and the second container image in a container registry.

16. The computer-implemented method of claim 15, wherein the container registry is in the cloud.

17. A system comprising:
a data store;
a model library;
an application library;
at least one processor; and
memory storing instructions that, when executed by the at least one processor, cause the system to:
receive a first request for using a model in a first context;
determine a first contextual application from a plurality of applications based on the first context;
retrieve the model from the application library and the first application from a model library; and
package the first contextual application and the model in a first container image.

18. The system of claim 17, wherein the instructions, when executed by the at least one processor, cause the system to:
receive a second request for using the model in a second context;
determine a second contextual application from the plurality of applications based on the second context;
retrieve the second contextual application from the application library; and
package the second contextual application and the model in a second container image.

19. The system of claim 17, further comprising a data store, wherein the instructions, when executed by the at least one processor, cause the system to:
receive a set of training data; and
store the set of training data in the data store.

20. The system of claim 19, wherein the instructions, when executed by the at least one processor, cause the system to:
generate a model using the set of training data.

21. The system of claim 17, further comprising a container registry, wherein the instructions, when executed by the at least one processor, cause the system to:
save the first container image in the container image registry.

22. The system of claim 21, wherein the container registry is in the cloud.
